(19) United States
(12) Patent Application Publication
(10) Pub. No.: US 2008/0276753 A1
(43) Pub. Date: Nov. 13, 2008

(54) Method of Manufacturing Cam Shaft, Cam Shaft, and Cam Lobe Material Used in the Same

(76) Inventor: Hiroyuki Takamura, Tochigi (JP)

Correspondence Address: STEPTOE & JOHNSON LLP, 1330 CONNECTICUT AVENUE, N.W., WASHINGTON, DC, 20036, US

(21) Appl. No.: 10/577,312

(22) PCT Filed: Oct. 28, 2004
(86) PCT No.: PCT/JP04/16046

§ 371 Date: Apr. 28, 2006

(30) Foreign Application Priority Data
Oct. 31, 2003 (JP) 2003-373174

(51) Int. Cl. F01L 1/047; B23P 15/00; F16H 53/02; C21D 9/30

(52) U.S. Cl. 74/567; 29/888.1; 148/95; 123/90.6; 148/559

(57) ABSTRACT

A method of manufacturing a cam shaft that prevents cracks during the joining of a cam lobe to a shaft, and improves the degree of freedom of design of the cam lobe is provided.

By a method of manufacturing a cam shaft that after an inner circumferential surface 13 of a cam lobe 1 is subjected to treatment for residual compressive stress addition treatment, the cam lob 1 is joined to a shaft, above problem is solved. It is preferred that the residual compressive stress on the inner circumferential surface 13 of the cam lobe 1 is not less than 100 MPa. In addition, an outer peripheral surface 14 of the cam lobe 1 can be also subjected to treatment for residual compressive stress addition treatment. As the treatment for residual compressive stress addition treatment, shot-peening treatment, induction hardening treatment, barrel polishing treatment, carburizing and quenching treatment or carbonitriding treatment is performed.

### TECHNICAL FIELD

The present invention relates to a method of manufacturing a cam shaft used in an internal combustion engine, a cam shaft, and a cam lobe material used in the cam shaft.

### BACKGROUND ART

A cam shaft is used in a valve train of an internal combustion engine. In such an internal combustion engine, parts such as cam shaft and rocker arm slide at high speeds during operation and hence they are required to have sliding characteristics such as wear resistance, pitting resistance and scuffing resistance.

For this reason, there has hitherto been used a cam shaft that is provided with a chilled cam in which a cam nose portion is rapidly cooled and caused to solidify during casting by using a chiller in this part, whereby a hard white cast iron structure is formed in the surface part of the cam nose. This chilled cam shaft, which has a hard chilled structure on its peripheral surface, has excellent wear resistance and scuffing resistance.

On the other hand, in recent years, assembly type cam shafts have been frequently used to achieve the weight reduction of engines. In the joining of the cam lobe and a shaft of this assembly type cam shaft, fabrication methods such as elastic fitting (joining that utilizes the elastic deformation of the cam lobe and the plastic deformation of the shaft) and press fitting are frequently used. In these fabrication methods, the cam lobe is mounted in a prescribed position of the shaft, with the outside diameter of the shaft kept smaller than the inside diameter of the cam lobe, the shaft is fitted onto the inner circumferential circle of the cam lobe by expanding the outside diameter of the shaft larger than the inside diameter of the cam lobe with utilizing thermal expansion and elastic force etc., and by utilizing the contact pressure generated by this fitting, a frictional force generated on this occasion is caused to joint the shaft and the cam lobe together. When a difference between the inside diameter of the cam lobe before the expansion of the outside diameter of the shaft and the outside diameter of the shaft after the expansion of the outside diameter of the shaft (hereinafter called an interference) is increased, the contact pressure rises and the joining strength between the shaft and the cam lobe increases.

To achieve the weight reduction and miniaturization of an engine, it is possible to reduce the weight and size of a cam shaft. For this purpose, it is effective to reduce the base wall thickness of a cam lobe (the thickness between the inner circumferential surface and the outer peripheral surface of a cam base portion) and to reduce the width of the cam lobe (the width of the cam lobe in the direction parallel to a shaft in the cam shaft).

There in known a steel cam lobe (A) in which before the joining of a cam to a steel pipe, the whole periphery of the steel cam lobe is surface hardened by induction heating and internal compressive stress is applied to the outer peripheral surface region (refer to Patent Document 1, for example). In this steel cam lobe (A), pitting resistance is increased.

Also, there is known a cast iron cam shaft (B) in which the whole cam lobe is high frequency quenched and an area in which residual compressive stress due to puenching is insufficient (the flank portion) is subjected to shot peening (refer to Patent Document 2, for example). The area in which residual compressive stress due to quenching is insufficient is, concretely, the part between cam base portion and the cam nose portion on the outer peripheral surface of the cam lobe.

In the fabrication methods that involve joining a cam to a steel pipe by elastic fitting and press fitting (shrinkage fit), there are known an assembly type cam shaft (C) in which a sintered cam is quench hardened in oil and tempered, and an assembly type cam shaft (D) in which the whole periphery of a cam lobe is hardened by hardening and annealing the whole periphery of a forged steel cam lobe (refer to Patent Document 3 and Patent Document 4, for example). In the assembly type cam shaft (C), owing to its manufacturing method, not only the outer peripheral surface of the cam lobe, but also the inner circumferential surface thereof is subjected to hardening treatment, and hence the cam lobe has good hardenability. Therefore, the Rockwell hardness of the cam shaft is not decreased greatly by tempering and the cam shaft has excellent rotating bending strength and long durable hours. However, the inner circumferential surface of the cam lobe is not positively subjected to treatment for residual compressive stress addition treatment. In the steel cam lobe of (D) above formed by hot forging and annealing, the inner circumferential surface of the cam lobe is not positively subjected to treatment for residual compressive stress addition treatment although only the outer peripheral surface region is subjected to hardening treatment.

Patent Document 1: Japanese Patent Laid-Open No. 8-4880

Patent Document 2: Japanese Utility Model Laid-Open No. 3-45950

Patent Document 3: Japanese Patent Publication No. 5-61347

Patent Document 4: Japanese Patent No. 3197613

### DISCLOSURE OF THE INVENTION

### Problems to be Solved by the Invention

The above-described chilled cam shaft had the problem that this shaft is inferior in pitting resistance although it has wear resistance and scuffing resistance.

In the case where the base wall thickness of a cam lobe is reduced in consideration of the weight reduction of an engine, if the wall thickness of the cam lobe is reduced with the same interference, cracks are initiated from the inner circumference of the cam lobe and tensile stress is applied to the periphery of the cam lobe, then repeated contact fatigue strength decrease.

Similarly, in the case where the width of a cam lobe is reduced, it is necessary to increase the interference in order to obtain the same joining torque (the force required by the shaft to rotate the cam lobe). As a result of this, in the same manner as in the case where the base wall thickness is decreased, cracks are generated in the cam lobe and a decrease in repeated contact fatigue strength occurs in the periphery of the cam lobe.

Thus, the cases where the shape of the cam lobe is changed had the problem that the kinds of engines to be used are limited, resulting in an insufficient degree of freedom of cam lobe design.

On the other hand, the cam lobe (A) in which the whole periphery is surface hardened by induction heating is applied internal compressive stress to the outer peripheral surface region. Therefore, elastic deformability is required in the inner circumferential surface of the cam lobe to some degree to expand a steel pipe for join to the cam lobe. For this reason, the internal compressive stress is superposed due to the tensile stresses in the outer peripheral surface region generated by cam joining after the joining of the cam to the steel pipe, and the internal compressive stress remains in the outer peripheral surface region of the cam lobe. On the other hand, tensile stress remains due to joining on the inner circumferential surface of this cam.

Also in the cast iron cam shaft (B) in which a quenched cam lobe is subjected to shot pinning, residual compressive stress is applied to the surface region of the whole periphery, and this cam shaft has the problem that elastic deformability is required on the inner circumferential surface of the cam shaft to some degree as with the above-described cam lobe in which the whole periphery is surface hardened by induction heating.

These cam shafts, the assembly type cam shaft (C) in which a sintered alloy is quench hardened in oil and tempered, and the assembly type cam shaft (D) in which the whole periphery of a steel cam lobe is hardened by forging and annealed do not solve the above-described problem of the degree of freedom of design in the base wall thickness and width of the cam lobe although they have pitting resistance due to the hardening of the outer peripheral surface of the cam lobe.

Therefore, the present invention has as its object the provision of a method of manufacturing a cam shaft, a cam shaft, and a cam lobe material used in the cam shaft that solves these problems, prevents cracks during the joining of a cam lobe to a shaft, and improves the degree of freedom of design of the cam lobe.

### Means for Solving the Problems

A method of manufacturing a cam shaft of a present invention for solving the above-mentioned problem is characterized in that after an inner circumferential surface of a cam lobe is subjected to treatment for residual compressive stress addition treatment, the cam lob is joined to a shaft.

According to the present invention, by subjecting an inner circumferential (peripheral) surface of a cam lobe to treatment for residual compressive stress addition treatment, it is possible to apply residual compressive stress to the treated surface. As a result of this, in the assembly that involves inserting a shaft onto the inner circumferential circle of the cam lobe, it is possible to expand the allowance of stress, which the inner circumferential surface is capable of withstanding. As a result of this, cracks are less apt to be formed in the cam lobe during the joining of the shaft to the cam lobe, it is possible to reduce the base wall thickness of the cam lobe and the width of the cam lobe, and the degree of freedom of cam lob design increases. Also, it is possible to increase the interference and a dynamic junction torque can be improved.

In the present invention described above, characterized in that the residual compressive stress on the inner circumferential surface of the cam lobe is not less than 100 MPa.

According to the present invention, because residual compressive stress on the inner circumferential surface of the cam lobe is not less than a prescribed value, it is possible to provide a cam shaft that produces the above-described effects remarkably.

In the present invention described above, characterized in that after an outer peripheral surface of the cam lobe is further subjected to treatment for residual compressive stress addition treatment, the cam lobe is joined to the shaft.

According to the present invention, residual compressive stress is applied also to the outer peripheral (circumferential) surface of the cam lobe. Therefore, in addition to the above-described actions, the repeated contact fatigue strength of the cam shaft is improved and the pitting wear that might occur when a manufactured cam shaft is brought into actual working becomes less apt to occur.

In the present invention described above, characterized in that residual compressive stress on the outer peripheral surface of the cam lobe is not less than 100 MPa.

According to the present invention, because residual compressive stress on the outer peripheral surface of the cam lobe is not less than a prescribed value, it is possible to provide a cam shaft that produces the above-described effects remarkably.

In the present invention described above, characterized in that the treatment for residual compressive stress addition treatment is at least any one of shot-peening treatment, induction hardening treatment, barrel polishing treatment, carburizing and quenching treatment or carbonitriding treatment.

According to the present invention, it is possible to apply residual compressive stress only to the inner circumferential surface of the cam lobe by shot peening treatment (shot blasting treatment) or induction hardening, and it is possible to provide a cam shaft that produces the above-described effects. Furthermore, according to these treatments, it is possible to apply residual compressive stress to the inner circumferential surface and the outer peripheral surface of the cam lobe by different kinds of treatment. Also, by use of barrel polishing treatment, carburizing and quenching treatment or carbonitriding treatment, residual compressive stress can be applied simultaneously to the inner circumferential surface and the outer peripheral surface of the cam lobe. Thus, it is possible to provide a cam shaft that has the above-described actions.

A cam shaft of a present invention for solving the above-mentioned problem is characterized in that the cam shaft has a cam lobe in which an inner circumferential surface is subjected to treatment for residual compressive stress addition treatment.

According to the present invention, because an inner circumferential surface of a cam lobe is subjected to treatment for residual compressive stress addition treatment, it is possible to apply residual compressive stress to the treated surface. As a result of this, in the assembly that involves inserting a shaft onto the inner circumferential circle of the cam lobe, it is possible to expand the allowance of stress which the inner circumferential surface is capable of withstanding. As a result of this, cracks are less apt to be formed in the cam lobe during the joining of the shaft to the cam lobe, it is possible to reduce the base wall thickness of the cam lobe and the width of the cam lobe, and the degree of freedom of cam lob design increases. Also, it is possible to increase the interference during the joining of the cam lobe to the shaft and a dynamic junction torque can be improved.

A cam lobe material of a present invention for solving the above-mentioned problem is characterized in that an inner circumferential surface of the cam lobe material is subjected to treatment for residual compressive stress addition treatment.

According to the present invention, because an inner circumferential surface of a cam lobe is subjected to treatment for residual compressive stress addition treatment, it is possible to apply residual compressive stress to the treated surface. As a result of this, in the assembly that involves inserting a shaft onto the inner circumferential circle of the cam lobe, it is possible to expand the allowance of stress which the inner circumferential surface is capable of withstanding. Therefore, cracks are less apt to be formed in the cam lobe during the joining of the shaft to the cam lobe, it is possible to reduce the base wall thickness of the cam lobe and the width of the cam lobe, and the degree of freedom of cam lob design increases. Also, it is possible to increase the interference and a dynamic junction torque can be improved.

### ADVANTAGES OF THE INVENTION

According to a method of manufacturing a cam shaft of the present invention, by subjecting an inner circumferential surface of a cam lobe to treatment for residual compressive stress addition treatment, it is possible to apply residual compressive stress to the treated surface. As a result of this, in the assembly that involves inserting a shaft onto the inner circumferential circle of the cam lobe, it is possible to expand the allowance of stress which the inner circumferential surface is capable of withstanding. As a result of this, cracks are less apt to be formed in the cam lobe during the joining of the shaft to the cam lobe, it is possible to reduce the base wall thickness of the cam lobe and the width of the cam lobe, and the degree of freedom of cam lob design increases. Also, it is possible to increase the interference and a dynamic junction torque can be improved. Furthermore, by applying residual compressive stress also to an outer peripheral surface of the cam lobe, the repeated contact fatigue strength of the cam shaft is improved and the pitting wear that might occur when a manufactured cam shaft is brought into service becomes less apt to occur.

### BRIEF DESCRIPTION OF THE DRAWINGS

FIGS. 1A and 1B are a sectional view and a plan view, respectively, of an example of a cam lobe of the present invention;

FIG. 2 is a partial perspective view of an example of a cam shaft of the present invention;

FIG. 3 is a schematic view that shows how a measurement test of the frequency of occurrence of pitting in a test piece in an example;

FIGS. 4A to 4E are each a graph that shows results of a measurement test of the frequency of occurrence of pitting in an example;

FIG. 5 is a schematic representation of internal residual stress distribution in an example; and

FIGS. 6A and 6B are each a graph showing the amount of austenite in a test piece before and after a measurement test of the frequency of occurrence of pitting in an example.

### EXPLANATION OF SYMBOLS

1 Cam lobe
11 Cam nose portion
12 Cam base portion
13 Inner circumferential surface of cam lobe
14 Outer peripheral surface of cam lobe
15 Inner circumferential circle of cam lobe
16 Wall thickness of cam base portion
17 Width of cam lobe
2 Cam shaft
3 Shaft
4 Test piece
41 Rotational direction of test piece
5 Mating material in the test
51 Rotational direction of mating material
6 Lubricating oil
7 Load
O Center of inner circumferential circle of cam lobe

### BEST MODE FOR CARRYING OUT THE INVENTION

A method of manufacturing a cam shaft of the present invention will be described below with reference to the accompanying drawings.

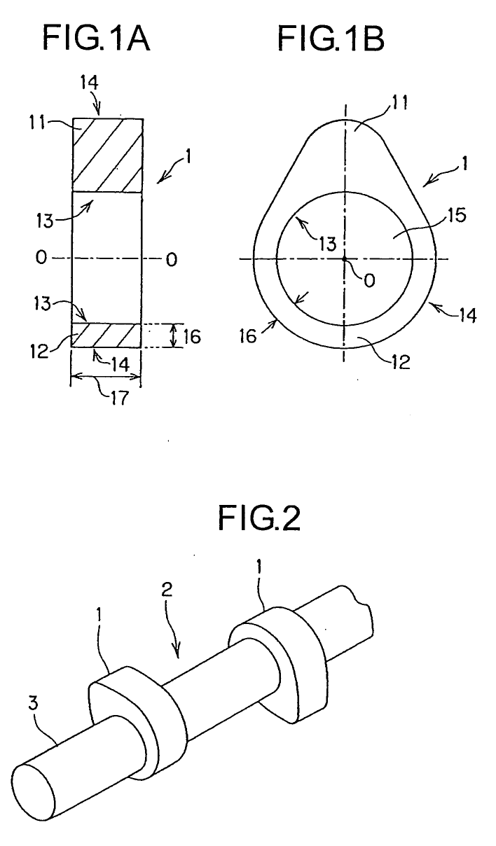

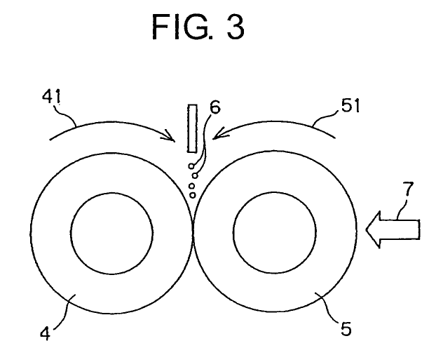

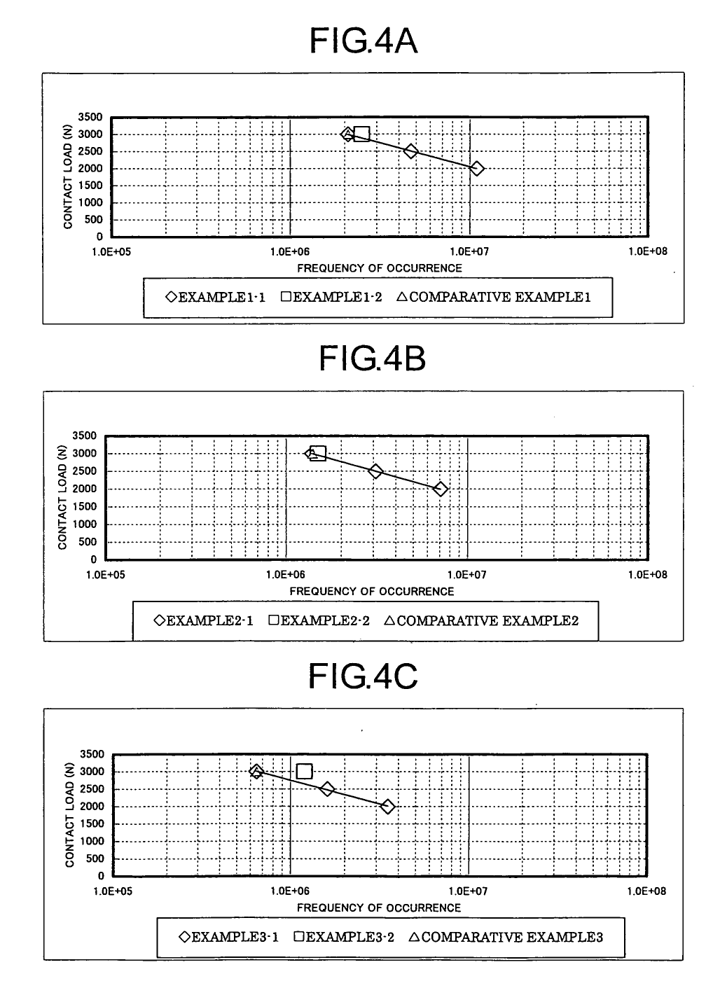

First, FIGS. 1A and 1B show, respectively, a sectional view taken so as to pass the center O of an inner circumferential circle 15 of a cam lobe 1 used in the present invention and the leading end of a cam nose portion 11 and a plan (front) view of the cam lobe. FIG. 2 shows an example of a camshaft 2 manufactured according to the present invention. Incidentally, FIG. 3 to FIGS. 6A and 6B, which related to examples, will be described later.

In a manufacturing method of the cam shaft 2 of the present invention, after an inner circumferential surface 13 of the cam lobe 1 is subjected to treatment for residual compressive stress addition treatment, this cam lobe 1 is joined to the shaft 3. Incidentally, the inner circumferential surface 13 of the cam lobe 1 refers to a portion where the cam lobe 1 joins to the shaft 3 when the cam lobe 1 is used in the cam shaft 2.

Residual compressive stress on the inner circumferential surface 13 of the cam lobe 1 is not less than 100 MPa, after performing treatment for residual compressive stress addition treatment like above. Although an upper limit value of this residual compressive stress is not especially limited, it is usually 1200 MPa. Residual compressive stress on the inner circumferential surface 13 of the cam lobe 1 is preferably 300 to 1000 MPa or so. Incidentally, this residual compressive stress is measured by stress measurement that uses X-ray diffraction.

By applying residual compressive stress to the inner circumferential surface 13 of the cam lobe 1 like this, in the assembly that involves inserting the shaft 3 onto (into) the inner circumferential circle 15 of the cam lobe 1, it is possible to expand the allowance of stress which the inner circumferential surface 13 is capable of withstanding. As a result of this, cracks are less apt to be formed in the cam lobe 1 during the joining of the shaft 3 to the cam lobe 1, it is possible to reduce the base wall thickness 16 of the cam lobe 1 and the width 17 of the cam lobe 1, and the degree of freedom of cam lob 1 design increases. For this reason, it is possible to achieve the weight reduction of a cam shaft according to the present invention and the cam shaft can be used in engines of various types. Also, the interference can be increased and a dynamic junction torque can be increased.

Furthermore, in a manufacturing method of the cam shaft 2 of the present invention, also the outer peripheral surface 14 of the cam lobe 1 can be subjected to treatment for residual compressive stress addition treatment in addition to the inner circumferential surface 13 of the cam lobe 1. Incidentally, the outer peripheral surface 14 of the cam lobe 1 refers to the surface that slides with a cam follower when the cam lobe 1 is used in the cam shaft 2. This treatment for residual compressive stress addition treatment is the same as the above-described one, which was explained as the treatment for the inner circumferential surface 13 of the cam lobe.

Residual compressive stress on the outer peripheral surface 14 of the cam lobe 1 after performing treatment for residual compressive stress addition treatment like this is not less than 100 MPa. Although an upper limit value of this residual compressive stress is not especially limited, it is usually 1200 MPa. Residual compressive stress on the outer peripheral surface 14 of the cam lobe 1 is preferably 300 to 1000 MPa or so. Incidentally, this residual compressive stress is measured in the same manner as the above-described method for the inner circumferential surface 13 of the cam lobe.

By applying residual compressive stress also to the outer peripheral surface 14 of the cam lobe 1 like this, the repeated contact fatigue strength of the cam shaft 2 is improved and the pitting wear that might occur when a manufactured cam shaft 2 is brought into service becomes less apt to occur.

Treatment for residual compressive stress addition treatment is not especially limited so long as it is a treatment capable of applying residual compressive stress only to the inner circumferential surface 13 of the cam lobe 1 or both the inner circumferential surface 13 and the outer peripheral surface 14. Concretely, however, shot peening treatment (shot blasting treatment), induction hardening treatment, barrel polishing treatment, carburizing and quenching treatment, carbonitriding treatment, etc. can be mentioned.

Shot peening treatment (shot blasting treatment) is usually performed by adjusting the nozzle so that the surface of the cam lobe material 1 (only the inner circumferential surface 13 or both the inner circumferential surface 13 and the outer peripheral surface 14) can be shot blasted and causing grits of steel, glass beads, etc. to strike against the surface of the cam lobe material 1 at a pressure of 5 kg/cm² or so with the aid of compressed air, centrifugal force, etc.

Induction hardening treatment is a treatment that involves heating the surface portion of the cam lobe material 1 to be treated (only the inner circumferential surface 13 or both the inner circumferential surface 13 and the outer peripheral surface 14) to an appropriate temperature of not less than the Ac₃ or Ac₁ transformation point by induction heating, then cooling this surface portion with an appropriate coolant, heating it to an appropriate temperature of not more than the Ac₁ transformation point in order to adjust hardness and increase toughness, and cooling after that.

When the above-described shot peening treatment (shot blasting treatment) or induction hardening treatment is performed, it is possible to apply residual compressive stress only to the inner circumferential surface 13 of the cam lobe 1 and besides it is also possible to apply residual compressive stress to the inner circumferential surface 13 and the outer peripheral surface 14 of the cam lobe 1 by the same treatment. Also, it is possible to apply residual compressive stress to the inner circumferential surface 13 and the outer peripheral surface 14 of the cam lobe 1 by performing treatments that are different from each other.

In barrel polishing treatment, the cam lobe material 1, along with a polishing aid and abrasives such as silica sand, is rotated or the cam lobe material 1 is put in a vibrating container and vibrated, whereby the inner circumferential surface 13 and the outer peripheral surface 14 of the cam lobe 1 are polished.

Carburizing and quenching treatment refers to a treatment that involves heating the cam lobe material 1 in a medium containing carbon and hardening the surface of the cam lobe material 1 by raising the carbon content of the surface, then hardening the surface of the cam lobe material 1 by quenching.

Carbonitriding treatment refers to a treatment that involves heating the cam lobe material 1 in a medium containing carbon and nitrogen and hardening the surface of the cam lobe material 1 by penetrating carbon and nitrogen into the surface.

By performing the barrel polishing treatment, carburizing and quenching treatment or carbonitriding treatment, it is possible to simultaneously apply residual compressive stress to the inner circumferential surface 13 and the outer peripheral surface 14 of the cam lobe 1.

An assembly type cam shaft 2 as shown in FIG. 2 is obtained by joining the cam lobe 1 thus subjected to prescribed treatment to the shaft 3. Concretely, this assembly type cam shaft 2 can be obtained, for example, by mounting and fixing the cam lobe 1 in a prescribed position of the shaft 3 at a prescribed angle by performing shrinkage fit or cooling fit. The shrinkage fit and cooling fit are advantageously used in terms of assembling accuracy and low equipment cost.

The joining torque in the cam shaft 2 thus manufactured is usually 100 to 500 Nm or so, preferably 150 to 400 Nm or so. The joining torque is indicated by values measured in a torsion test.

Incidentally, the cam shaft 2 thus manufactured may be provided with only the above-described cam lobe 1 according to the present invention or may be provided with the cam lobe 1 according to the present invention and a cam lobe having other qualities (sliding characteristics etc.).

According to a manufacturing method of the cam lobe 1 of the present invention, as described above, it is possible to provide a cam shaft 2 in which cracks are less apt to be formed in the cam lobe 1 and which has a degree of freedom of design and can be used various kinds of engines, for example, a light-weight and compact engine and an engine to which high loads are applied.

Although the chemical composition of the cam lobe 1 of the present invention described above is not especially limited, it is possible to use, for example, an iron-based sintered alloy that contains, for example, 0.8 to 1.2% by mass of C (carbon), 0.5 to 4.0% by mass of Ni (nickel), 0.1 to 2.0% by mass of Mo (molybdenum) and incidental impurities as the balance. The incidental impurities include lubricants such as zinc stearate that are added to sintering powders and residues of other additive components in addition to trace amounts of impurities that get mixed into raw material powders.

The density of the cam lobe material 1 used in a manufacturing method of the present invention, which is not especially limited, is usually 7.3 to 7.6 g/cm³ or so. When the density is ensured to such an extent, it is possible to provide a cam lobe material advantageous in terms of strength and pitting resistance and this cam lobe material can also be used in engines to which high loads are applied.

The hardness of the outer peripheral surface 14 (the surface subjected to treatment for residual stress application) of the cam lobe material 1 used in a manufacturing method of the present invention, which is not especially limited, is usually Rockwell hardness HRC 50 to 55 or so. When the hardness is ensured to such an extent, the cam shaft 2 obtains preferable wear resistance.

In the cam lobe material 1 used in a manufacturing method of the present invention, the amount of austenite before the use as the cam shaft 2 is 3.0 to 35% by volume or so. The amount of austenite after this cam lobe material 1 is used in the cam shaft 2, which is brought into service (caused to slide) is 2.0 to 20% by volume or so. Because the amount of austenite decreases after sliding like this, it might be thought that strain-induced martensitic transformation has occurred.

Materials for the shaft 3 used in a manufacturing method of the present invention are not especially limited so long as they are generally used in the cam shaft 2 of an internal combustion engine. A shaft 3 fabricated from S45C, for example, is used.

The above-described cam lobe 1 used in the present invention is fabricated as follows before the treatment for residual compressive stress addition treatment. First, iron-based powders are blended and prepared in such a manner as to finally obtain a desired chemical composition. These iron-based powders are mixed so that each component is uniformly mixed, and compression molded to a prescribed shape as shown in FIG. 1B, for example. After that, sintering is performed. The compression molding and sintering may be performed twice or more. Incidentally, the second and later compression molding is performed after sintering.

The cam lobe 1 at least the inner circumferential surface 13 of which is subjected to treatment for residual compressive stress addition treatment becomes a cam lobe of the present invention. And the cam shaft 2 provided with the cam lobe 1 at least the inner circumferential surface 13 of which is subjected to treatment for residual compressive stress addition treatment as described above becomes a cam shaft of the present invention.

### EXAMPLES

The present invention will be more concretely described below on the basis of examples and comparative examples.

### Example 1

After secondary sintering, iron-based alloy powders consisting essentially of 0.8% by mass of C, 3.5% by mass of Ni, 0.3% by mass of Mo, and the balance Fe and incidental impurities were prepared, zinc stearate was added as a lubricant to the iron-based alloy powders, and they were mixed together. Next, the mixture was compression molded (primary molding) to the shape of the cam lobe 1 at a compressive load of 5 to 7 tons/cm² and then temporarily sintered (primary sintering) at 600 to 900° C. in a vacuum sintering furnace. Furthermore, to the primary sintered body, compression molding (secondary molding) was performed at a compressive load of 7 to 10 tons/cm² and regular sintering (secondary sintering) was then performed at 1100 to 1200° C. in the vacuum sintering furnace. Subsequently, this sintered body was subjected to quenching and tempering treatment (heating at 900° C. for 100 minutes, then oil quenching, further heating at 150° C. for 60 minutes, then air cooling), whereby a cam lobe material 1 was fabricated.

As Example 1-1, only the inner circumferential surface 13 of a cam lobe material was subjected to treatment for residual compressive stress addition treatment (shot peening treatment) after regular sintering (secondary sintering) was performed in the same manner as in Example 1, whereby the cam lobe material 1 was prepared. Also, as Example 1-2, both of the inner circumferential surface 13 and the outer peripheral surface 14 of a cam lobe material was subjected to treatment for residual compressive stress addition treatment (induction hardening) after regular sintering (secondary sintering) was performed in the same manner as in Example 1, whereby the cam lobe material 1 was prepared.

### Examples 2 to 5

Sintered bodies were fabricated in the same manner as with Example 1 from iron-based alloy powders to obtain the chemical compositions shown in Table 1 after secondary sintering, heat treatment similar to that of Example 1 was performed, and the cam lobe materials 1 of Examples 2 to 5 were obtained.

For each of the examples with a numeral “−1,” Examples 2-1, 3-1, 4-1 and 5-1, only the inner circumferential surface 13 of a cam lobe material was subjected to treatment for residual compressive stress addition treatment in the same manner as with Example 1-1, whereby the cam lobe material 1 was fabricated. Also, for each of the examples with a numeral “−2,” Examples 1-2, 2-2, 3-2, 4-2 and 5-2, both of the inner circumferential surface 13 and the outer peripheral surface 14 of a cam lobe material was subjected to treatment for residual compressive stress addition treatment, whereby the cam lobe material 1 was fabricated.

### Comparative Examples 1 to 5

Sintered bodies were fabricated by using the same chemical composition and manufacturing method as with Example 1 and treatment for residual compressive stress addition treatment was not performed, whereby the cam lobe material of Comparative Example 1 was obtained. Similarly, sintered bodies were fabricated by using the same chemical compositions and manufacturing method as with Examples 2 to 5 and treatment for residual compressive stress addition treatment was not performed, whereby the cam lobe materials of Comparative Examples 2 to 5 were obtained.

### Comparative Example 6

Each element was melted in such a manner as to obtain a final chemical composition consisting essentially of 3.4% by mass of C, 2.0% by mass of Si, 0.7% by mass of Mn, 0.8% by mass of Cr, 2.0% by mass of Mo, 2.0% by mass of Ni+Cu, and the balance Fe and incidental impurities, the melt was poured into a mold having a chiller and rapidly cooled, and chilled cast iron was obtained by solidification. The cam lobe material of Comparative Example 6 was obtained by polishing the chilled cast iron thus obtained.

### Comparative Example 7

Iron-based alloy powders consisting essentially of 0.8% by mass of C and the balance Fe and incidental impurities were prepared after secondary sintering and the cam lobe material of Comparative Example 7 was obtained in the same manner as with the manufacturing method of Example 1.

### (Evaluation Method)

Table 1 shows the chemical compositions of the cam lobes obtained in each of the examples and each of the comparative examples. For the cam lobes obtained in each of the examples and each of the comparative examples, measurements were made of the residual stress of the inner circumferential surface and the outer peripheral surface, joining torque, limit to the cam-lobe wall thickness, density, Rockwell hardness HRC of the outer peripheral surface, the frequency of occurrence of pitting, internal stress distribution, and the amount of austenite before and after the test to measure the frequency of occurrence of pitting. The results of the measurements are shown in Table 2.

The residual stress of the inner circumferential surface and the outer peripheral surface was measured by X-ray stress measurement. The joining torque was measured by performing a torsion test (after the joining of the cam lobe to an end piece of S45C, the end piece was fixed, and the cam lobe was evaluated in terms of torsion). For the limit to the cam-lobe wall thickness, the periphery of the cam lobe was lathed after the assembling of the cam shaft, and the wall thickness of the cam lobe at which a crack was formed was measured.

The density was measured by Archimedes' method after the sealing treatment of a test piece of the cam lobe material with paraffin. For the Rockwell hardness HRC of the outer peripheral surface, the periphery of the cam nose portion of a test piece of the cam lobe material was measured at five points with a Rockwell hardness meter on C scale and an average value of the measurements was calculated.

The test to determine the frequency of occurrence of pitting was performed as follows. By use of a double cylinder contact testing machine shown in FIG. 3, the frequency of occurrence of pitting was measured. Each test piece 4 was caused to rotate at a constant speed (arrow 41), a rotary surface (in the direction of arrow 51) of a cylindrical test piece 5, which is a mating member, was brought into contact with the test piece 4, rotation was performed by applying a prescribed load 7 while a lubricating oil 6 was caused to drop onto the contact surfaces of the two test pieces 4 and 5, and the number of revolutions until the occurrence of pitting was measured.

### (Test Conditions)

Measuring device: Double cylinder contact testing machine

Speed of revolutions: 1500 rpm

Lubricating oil: Engine oil 10W30

Oil temperature: 100° C.

Oil volume: 2×10⁻⁴ m³/min

Load: 2000 N (Examples 1-1, 2-1, 3-1, 4-1, and 5-1, Comparative Examples 6 and 7)
2500N (Examples 1-1, 2-1, 3-1, 4-1, and 5-1, Comparative Examples 6 and 7)
3000 N (Examples 1-1, 2-1, 3-1, 4-1, and 5-1, Examples 1-2, 2-2, 3-2, 4-2, and 5-2, Comparative Examples 1 to 7)

Slip ratio: 0%

Mating member: SUJ2

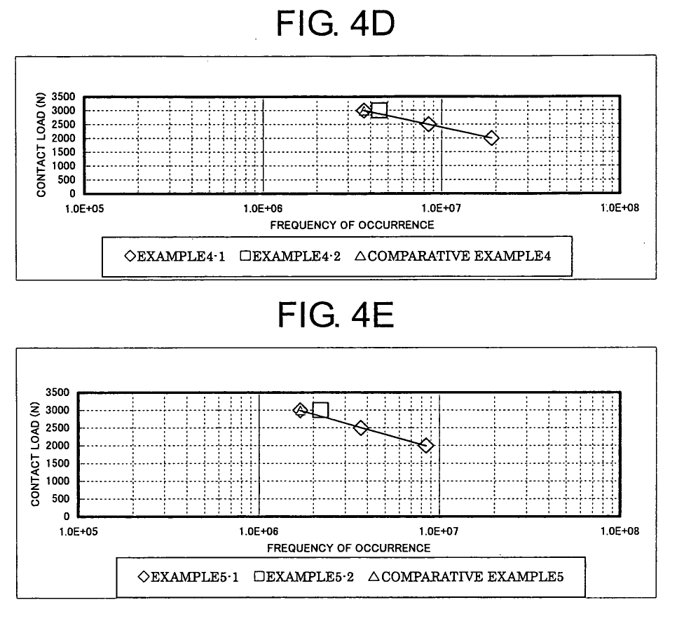

Judgment method: A crack of the occurrence of pitting was detected from AE (acoustic emission) and the frequency of contact at that time was regarded as the frequency of occurrence of pitting. The relationship between the frequency of occurrence of pitting and the load at that time (S-N curve) is shown in FIGS. 4A to 4E.

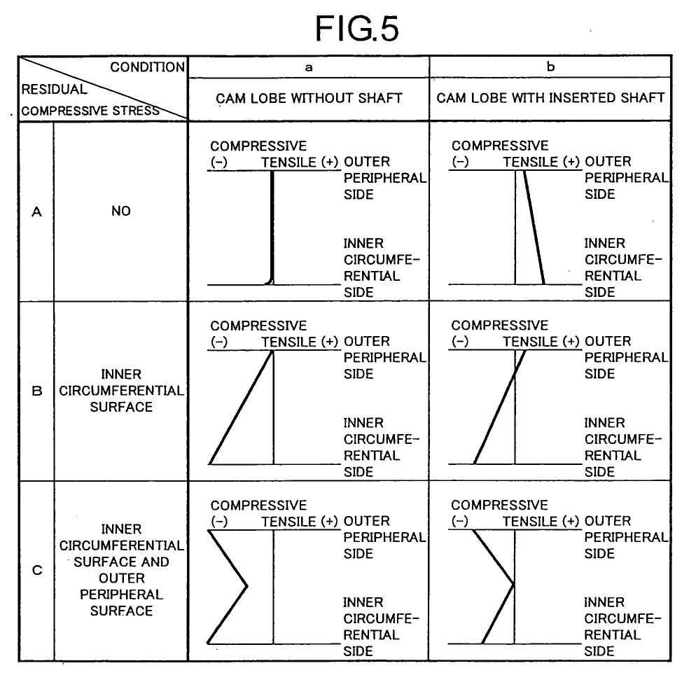

For the internal stress distribution, FIG. 5 is a schematic representation of internal residual stress distribution in a section from the inner circumferential side to the outer peripheral side of a cam lobe in two conditions: (a) cam lobe without shaft and (b) cam lobe with inserted shaft (in a case where the shaft is joined to the cam lobe by shrinkage fit).

Concretely, A/a of FIG. 5 shows internal stress distribution in a cam lobe without a shaft in a case where the inner circumferential surface of the cam lobe is not subjected to treatment for residual compressive stress addition treatment.

A/b of FIG. 5 shows internal stress distribution in a case where a shaft is inserted into a cam lobe, the inner circumferential surface of which is not subjected to treatment for residual compressive stress addition treatment, and joined by shrinkage fit.

B/a of FIG. 5 shows internal stress distribution in a cam lobe without a shaft in a case where only the inner circumferential surface of the cam lobe is subjected to treatment for residual compressive stress addition treatment.

B/b of FIG. 5 shows internal stress distribution in a case where a shaft is inserted into a cam lobe, only the inner circumferential surface of which is subjected to treatment for residual compressive stress addition treatment, and joined by shrinkage fit.

C/a of FIG. 5 shows internal stress distribution in a cam lobe without a shaft in a case where both of the inner circumferential surface and the outer peripheral surface of the cam lobe are subjected to treatment for residual compressive stress addition treatment.

C/b of FIG. 5 shows internal stress distribution in a case where a shaft is inserted into a cam lobe, both of the inner circumferential surface and the outer peripheral surface of which are subjected to treatment for residual compressive stress addition treatment, and joined by shrinkage fit.

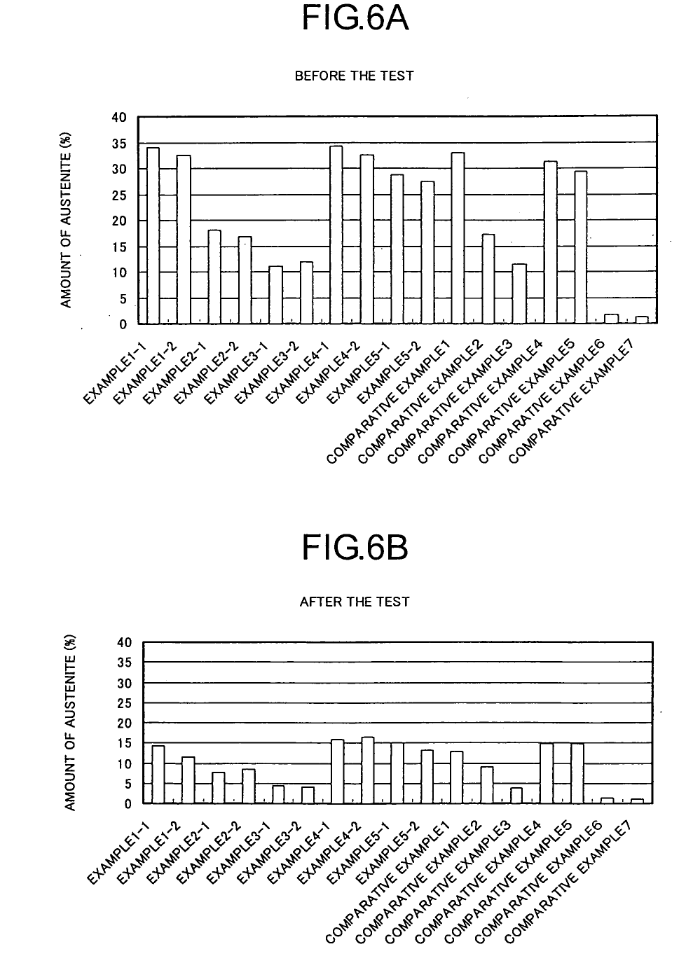

The measurement of the amount of austenite was made by use of an X-ray stress measuring device (made by KABUSHIKIKAISHA Rigaku) and the outer peripheral part of each test piece was measured. FIG. 6A shows measurement results before the test to measure the frequency of occurrence of pitting, FIG. 6B shows measurement results after the test to measure the frequency of occurrence of pitting, and Table 2 shows both of the test results.

### (Evaluation Results)

Table 2 shows results of the test to determine the limit to the cam-lobe wall thickness. In all of the examples, Examples 1-1 and 1-2 to 5-1 and 5-2, the limit to the cam-lobe wall thickness is 0.8 to 1.3 mm and hence not more than 1.3 mm.

In Comparative Examples 1 to 5, 7, the limit to the cam-lobe wall thickness is 2.0 to 2.8 mm and hence not less than 2.0 mm.

In all of the examples, Examples 1-1 and 1-2 to 5-1 and 5-2, it is possible to reduce the limit to the cam-lobe wall thickness by about 1/2.5 (Example 4-1) to 1/1.5 (Example 2-1) compared to that of 2.0 mm in Comparative Example 1, the limit to the cam-lobe wall thickness of which is the smallest of all of the comparative examples.

This is because due to residual compressive stress addition treatment to the inner circumferential surface of the cam lobe, the tensile stress generated by the joining of the cam lobe to the shaft is canceled out and decreases, with the result that also due to the yield strength (yield point) of the cam lobe, the wall thickness at which a crack is formed decreases.

For this reason, in each of the examples of the present invention, it is possible to reduce the base wall thickness of the cam lobe and also the width of the cam lobe and hence the degree of freedom of cam lobe design is increased.

Also, in each of the examples of the present invention, it is possible to increase the interference and a dynamic junction torque can be increased.

Subsequently, the inner stress distribution is considered.

For A/a of FIG. 5, a small amount of working residual compressive stress by the working of the inner circumference by the joining to the shaft is distributed.

For A/b of FIG. 5, in the case of the cam lobe with the inserted shaft (shrinkage fit), tensile stress (+) that is inclined with a tendency to decrease from the inner circumferential side to the outer peripheral side is distributed.

For B/a of FIG. 5, in the case where residual compressive stress (−) is applied to the inner circumferential surface of the cam lobe, compressive stress (−) that is inclined with a tendency to decrease from the inner circumferential side to the outer peripheral side is distributed.

For B/b of FIG. 5, in the case of the cam lobe with the inserted shaft (shrinkage fit), the tensile stress (+) of A/b of FIG. 5 that is generated by joining and inclined with a tendency to decrease from the inner circumferential side to the outer peripheral side is superposed and canceled out, with the result that compressive stress (−) is distributed on the inner circumferential side and tensile stress (+) is distributed on the outer peripheral side.

For C/a of FIG. 5, in the case where residual compressive stress (−) is applied to both of the inner circumferential side and the outer peripheral side, compressive stress (−) is distributed on the inner circumferential side and the outer peripheral side, and similar compressive stress (−), which is smaller than on the inner circumferential side and the outer peripheral side, is distributed also roughly at the middle point between the inner circumferential side and the outer peripheral side.

For C/b of FIG. 5, in the case of the cam lobe with the inserted shaft (shrinkage fit), the tensile stress (+) of A/b of FIG. 5 that is generated by joining and inclined with a tendency to decrease from the inner circumferential side to the outer peripheral side is superposed and canceled out, with the result that compressive stress (−) is distributed on the inner circumferential side and the outer peripheral side, and residual stress is not generated (0) roughly at the middle point between the inner circumferential side and the outer peripheral side.

As described above, it became apparent that in each of the examples in which after the application of residual compressive stress (−) only to the inner circumferential surface of the cam lobe or both of the inner circumferential surface and the outer peripheral surface of the cam lobe, the shaft is inserted and joined (joining by shrinkage fit), as shown in “Limit to cam-lobe wall thickness” of table 2, it is possible to reduce the value of “Limit to cam-lobe wall thickness” than in the comparative examples.

In each of the examples with a numeral “−2,” Examples 1-2, 2-2, 3-2, 4-2 and 5-2 in which the outer peripheral surface 14 of the cam lobe is subjected to treatment for residual compressive stress addition treatment, as shown in FIGS. 4A to 4E, the frequency of occurrence of pitting is improved compared to each of the examples with a numeral “−1,” Examples 1-1, 2-1, 3-1, 4-1 and 5-1 and the comparative examples 1 to 5 in which the outer peripheral surface 14 of the cam lobe is not subjected to treatment for residual compressive stress addition treatment. This is because fatigue strength is improved by the application of residual compressive stress to the outer peripheral surface 14.

It became apparent that in each of the examples with a numeral “−2,” Examples 1-2, 2-2, 3-2, 4-2 and 5-2 in which after the application of residual compressive stress (−) to both of the inner circumferential surface and the outer peripheral surface of the cam lobe, which have the internal stress distribution shown in C/b of FIG. 5, the shaft is inserted and joined (joining by shrinkage fit), as shown in “Frequency of occurrence of pitting” of Table 2, it is possible to increase the frequency of occurrence of pitting compared to each of the examples with a numeral “−1,” Examples 1-1, 2-1, 3-1, 4-1 and 5-1, and each of the comparative examples.

In each of the comparative examples, the amount of austenite before the test to determine the frequency of occurrence of pitting is small compared to each of the examples. In each of the examples, the amount of austenite decreases after the test to determine the frequency of occurrence of pitting, although the amount of austenite little changes before and after the test in comparative examples 6 and 7.

TABLE 1

| | C | Ni | Mo | Si | Mn | Cr | Fe |
|---|---|---|---|---|---|---|---|
| Example 1 | 0.8 | 3.5 | 0.3 | — | — | — | Balance |
| Example 2 | 0.8 | 2.0 | — | — | — | — | Balance |
| Example 3 | 0.8 | 0.5 | — | — | — | — | Balance |
| Example 4 | 0.8 | 4.5 | — | — | — | — | Balance |
| Example 5 | 0.8 | 3.5 | 1.0 | — | — | — | Balance |
| Comparative | Same as Example 1 | | | | | | |
| Example 1 | | | | | | | |
| Comparative | Same as Example 2 | | | | | | |
| Example 2 | | | | | | | |
| Comparative | Same as Example 3 | | | | | | |
| Example 3 | | | | | | | |
| Comparative | Same as Example 4 | | | | | | |
| Example 4 | | | | | | | |
| Comparative | Same as Example 5 | | | | | | |
| Example 5 | | | | | | | |
| Comparative | 3.4 | 2.0 | 2.0 | 2.0 | 0.7 | 0.8 | Balance |
| Example 6 | | (Ni + Cu) | | | | | |
| Comparative | 0.8 | — | — | — | — | — | Balance |
| Example 7 | | | | | | | |

* Unit: mass %

TABLE 2

| | Residual stress | | | | | | | | | | |
|---|---|---|---|---|---|---|---|---|---|---|---|
| | [MPa] | | | Limit to | | | | | | Amount of | |
| | Inner | | | cam-lobe | | | Frequency of occurrence of | | | austenite | |
| | circum- | Outer | Joining | wall | | Hard- | pitching [times] | | | [% by volume] | |
| | ferential | peripheral | torque | thickness | Density | ness | Load [N] | | | Before | After |
| | surface | surface | N · m | mm | g/cm³ | HRC | 2000 | 2500 | 3000 | test | test |
| Example 1-1 | −310 | (104) | 325 | 1.0 | 7.47 | 52.0 | 1.1 × 10⁷ | 4.7 × 10⁶ | 2.1 × 10⁶ | 34.0 | 14.2 |
| Example 1-2 | −360 | −410 | 312 | 1.0 | 7.47 | 52.0 | — | — | 2.5 × 10⁶ | 32.5 | 11.5 |
| Example 2-1 | −380 | (106) | 310 | 1.3 | 7.45 | 51.5 | 7.1 × 10⁶ | 3.1 × 10⁶ | 1.4 × 10⁶ | 18.0 | 7.7 |
| Example 2-2 | −320 | −350 | 308 | 1.1 | 7.45 | 51.5 | — | — | 1.5 × 10⁶ | 16.8 | 8.5 |
| Example 3-1 | −350 | (120) | 299 | 1.2 | 7.42 | 51.0 | 3.5 × 10⁶ | 1.6 × 10⁶ | 6.5 × 10⁵ | 11.0 | 4.5 |
| Example 3-2 | −400 | −415 | 298 | 1.1 | 7.42 | 51.0 | — | — | 1.2 × 10⁶ | 12.0 | 4.1 |
| Example 4-1 | −360 | (110) | 328 | 0.8 | 7.51 | 54.0 | 1.9 × 10⁷ | 8.5 × 10⁶ | 3.7 × 10⁶ | 34.3 | 15.8 |
| Example 4-2 | −300 | −290 | 325 | 0.9 | 7.51 | 54.0 | — | — | 4.5 × 10⁶ | 32.6 | 16.5 |
| Example 5-1 | −410 | (93) | 310 | 0.9 | 7.46 | 56.0 | 8.5 × 10⁶ | 3.7 × 10⁶ | 1.7 × 10⁶ | 28.8 | 15.1 |
| Example 5-2 | −415 | −355 | 315 | 1.3 | 7.46 | 56.0 | — | — | 2.2 × 10⁶ | 27.5 | 13.2 |
| C.E. 1 | — | — | 318 | 2.0 | 7.47 | 52.0 | — | — | 2.1 × 10⁶ | 33.0 | 13.0 |
| C.E. 2 | — | — | 315 | 2.5 | 7.45 | 51.5 | — | — | 1.4 × 10⁶ | 17.3 | 9.1 |
| C.E. 3 | — | — | 305 | 2.2 | 7.42 | 51.0 | — | — | 6.5 × 10⁵ | 11.5 | 3.8 |
| C.E. 4 | — | — | 320 | 2.1 | 7.51 | 54.0 | — | — | 3.7 × 10⁶ | 31.3 | 14.9 |
| C.E. 5 | — | — | 318 | 2.3 | 7.46 | 56.0 | — | — | 1.7 × 10⁶ | 29.3 | 14.8 |
| C.E. 6 | — | — | — | — | — | 46.0 | 9.2 × 10⁵ | 4.1 × 10⁶ | 1.9 × 10⁵ | 1.6 | 1.5 |
| C.E. 7 | — | — | 288 | 2.8 | 7.46 | 49.0 | 8.2 × 10⁵ | 3.7 × 10⁵ | 1.7 × 10⁵ | 1.2 | 1..0 |

** C.E.: Comparative Example

1. A method of manufacturing a cam shaft, characterized in that after an inner circumferential surface of a cam lobe is subjected to treatment for residual compressive stress addition treatment, the cam lob is joined to a shaft.

2. The method of manufacturing a cam shaft according to claim 1, characterized in that the residual compressive stress on the inner circumferential surface of the cam lobe is not less than 100 MPa.

3. The method of manufacturing a cam shaft according to claim 1, characterized in that after an outer peripheral surface of the cam lobe is further subjected to treatment for residual compressive stress addition treatment, the cam lobe is joined to the shaft.

4. The method of manufacturing a cam shaft according to claim 1, characterized in that residual compressive stress on the outer peripheral surface of the cam lobe is not less than 100 MPa.

5. The method of manufacturing a cam shaft according to claim 1, characterized in that the treatment for residual compressive stress addition treatment is at least any one of shot-peening treatment, induction hardening treatment, barrel polishing treatment, carburizing and quenching treatment or carbonitriding treatment.

6. A cam shaft, characterized in that the cam shaft has a cam lobe in which an inner circumferential surface is subjected to treatment for residual compressive stress addition treatment.

7. A cam lobe material, characterized in that an inner circumferential surface of the cam lobe material is subjected to treatment for residual compressive stress addition treatment.
